(19) United States
(12) Patent Application Publication
(10) Pub. No.: US 2009/0017883 A1
(43) Pub. Date: Jan. 15, 2009

(54) CELL PHONE CASE

(76) Inventor: Tso Wei Lin, Arcadia, CA (US)

Correspondence Address: ROZSA LAW GROUP LC, 18757 BURBANK BOULEVARD, SUITE 220, TARZANA, CA, 91356-3346, US

(21) Appl. No.: 12/025,546

(22) Filed: Feb. 4, 2008

(30) Foreign Application Priority Data
Jul. 13, 2007 (CN) 200720054077.2

(51) Int. Cl. H04M 1/00

(52) U.S. Cl. 455/575.8; 455/575.1

(57) ABSTRACT

A case, including a housing the housing having an access opening for accessing the display panel of an enclosed electronic device, and a transparent protective cover panel having a pivotal connection to the body and an outwardly projecting lip pull formed along an edge thereof opposite the pivotal connection, and the body having an enlargement of the access opening for facilitating opening of the cover panel. Variations include structure for supporting the cover panel in plural predetermined open positions and orientations relative to the housing and for propping up the housing on a supporting surface.

### BACKGROUND

The present invention relates to accessories for hand-held electronic devices having display screens, such as cell phones, and more particularly to a case for such devices.

Cell phone cases of the prior art are generally directed to the ease of carry of the phones. For example, there are cases for receiving the phones for attachment to a waist belt. But these cases typically do not prevent the screen of the cell phone to rub against the inside of the case. With extended use, the screen is subject to damage, as in being scratched. With the increased use of LCD screens in smart phones, the screen damage issue is even more important. Therefore there is a need for a cell phone case that protects the screen, especially a LCD screen.

Thus there is a need for an improved case for an electronic devices such as a cell phone that has a display screen, that provides protection for the device and particularly the screen, and that permits convenient operation of the device.

### SUMMARY

The present invention meets this need by providing a case that is particularly effective for protecting an enclosed electronic device such as a cell phone, that is inexpensive to produce, and easy to use. In one aspect of the invention, the case includes a housing for holding an electronic device, the housing having an access opening for accessing a display panel of the device; and a protective cover or panel having a pivotal connection to the body and being movable between a closed position protectively covering the display panel and an open position, characterized by the protective panel having an outwardly projecting lip pull formed along an edge thereof opposite the pivotal connection, and the body having an enlargement of the access opening extending away from the lip pull in the closed position of the protective panel for facilitating opening of the panel. There can be catches on the panel for releasably holding the panel in the closed position.

Preferably the protective panel is engagable in a predetermined orientation relative to the housing for propping up the housing on an external supporting surface, with one edge of the housing and the edge of the protective panel having the lip pull contacting the supporting surface, and with the access opening facing generally upward. Preferably the panel is detachably attached to the body; more preferably, the panel has plural attachment locations on the body for providing plural predetermined open orientations of the panel.

The pivotal connection of the protective panel to the housing can be at a first attachment location, a second attachment location being proximate a bottom surface of the housing, wherein the protective panel is engeable in a predetermined orientation relative to the housing for propping up the housing on an external supporting surface, with one edge of the housing and the edge of the protective panel having the lip pull contacting the supporting surface, and with the access opening facing generally upward. The protective panel can be formed having a spaced pair of hinge tabs, each of the hinge tabs having an oppositely oriented boss projecting therefrom, the bosses being axially aligned, the housing being formed with the access opening having a pair of tab enlargements for clearing the hinge tabs, there being a pair of boss cavities formed in the housing adjacent each of the tab enlargements for snap pivotable engagement with the bosses; and the housing being formed having a spaced pair of openings at the second attachment location for receiving the bosses and portions of the hinge tabs of the protective panel. Preferably there is a third attachment location proximate the bottom surface of the housing for selectively orienting the protective panel for propping up the housing with a different edge of the housing and the edge of the protective panel having the lip pull contacting the supporting surface.

The housing can include an upper body and a lower body. There can be mating attachment elements formed on the upper body and the lower body for holding them in an assembled condition to releasably secure the electronic device within the housing. Preferably the protective panel is transparent for viewing a display of the electronic device while the panel is closed.

In another aspect of the invention, the cell phone case includes a housing for holding the electronic device, and having the access opening; and the protective panel having the pivotal connection to the body, wherein the panel is formed with the outwardly projecting lip pull formed opposite the pivotal connection for facilitating opening of the panel, the panel is engagable with the housing in a predetermined orientation relative to the housing for propping up the housing on an external supporting surface, with one edge of the housing and the edge of the protective panel having the lip pull contacting the supporting surface, and with the access opening facing generally upward.

When the user needs to use the phone, he can use the pull on the panel to lift the panel, in order to show the screen and the keyboard. When he is done with the use, he can just close the panel. The catches prevent the panel from opening up by itself during travel. The outwardly projecting pull on the opposite edge from the hinges makes it easy to open the panel. The matching opening enlargement on the panel facilitates insertion of the user's finger or thumb. The 2-piece body makes insertion and removal of the cell phone convenient. The panel can be transparent, so the user can see the screen, and/or removable, so if the user does not want the hassle of the flipping panel, he can remove it. The hinges can be installed from the underside so that once a closely fitting phone is inserted, it is not easy to detach (or lose) the panel. Alternatively, the panel can be snapped in place from the outside to facilitate removal with the phone in place.

### DRAWINGS

These and other features, aspects, and advantages of the present invention will become better understood with reference to the following description, appended claims, and accompanying drawings, where:

FIG. 1 is a perspective view of a protective case according to the present invention;

FIG. 2 is a perspective view as in Fig, 1, showing a protective panel of the case in an open position;

FIG. 3 is s side view of the case of FIG. 1 in the condition of FIG. 2;

FIG. 4 is a side view as in FIG. 3, showing a housing portion the case in an exploded condition;

FIG. 5 is a sectional elevational detail view on line 5-5 of FIG. 1;

FIG. 6 is a sectional elevational detail view on line 6-6 of FIG. 1;

FIG. 7 is a side elevational view showing an alternative configuration of the case of FIG. 1;

FIG. 8 is an elevational view as in FIG. 7, showing a protective panel thereof in a first open position;

FIG. 9 is an oblique elevational view showing the case of FIG. 7 with the protective panel in a second open position supporting a housing of the case in an inclined orientation;

FIG. 10 is a sectional plan detail view on line 10-10 of FIG. 7;

FIG. 11 is an oblique elevational view as in FIG. 9, with the protective panel in a third open position supporting a housing of the case in a different inclined orientation;

FIG. 12 is a bottom plan view showing another alternative configuration of the case of FIG. 1, a housing thereof having support openings formed therein;

FIG. 13 is a perspective view showing a protective panel of the case of FIG. 11 being moved into engagement with a first pair of the support openings;

FIG. 14 is a perspective view showing the case of FIG. 11 propped up with the supporting panel engaged with the first pair of support openings; and

FIG. 15 is an end elevational view showing the case of FIG. 11 propped up with the supporting panel engaged with a second pair of the support openings.

### DESCRIPTION

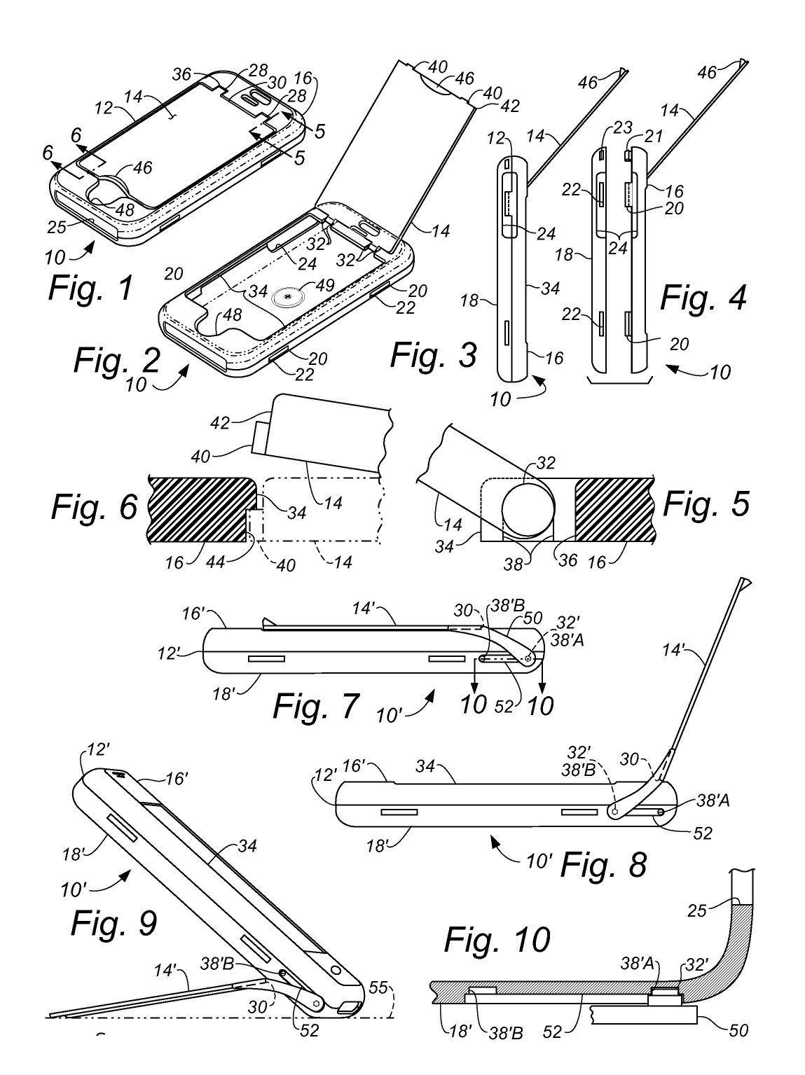

The present invention is directed to a protective case for a portable handheld electronic device that is particularly effective in both protecting and providing access to a graphic display panel of the device. With reference to FIGS. 1-6 of the drawings, a protective case 10 includes a housing 12 and a hingedly and detachably connected panel 14. The housing 12 includes an upper body 16 and a lower body 18. The upper body 16 has a plurality of attachment elements 20 that have snap engagement with corresponding cavities 22 that are formed in the lower body 18 as shown in FIG. 3 for securely affixing the two body pieces together as shown in FIGS. 1, 2, and 4. An additional attachment element 21 engages a corresponding cavity 23 that is located proximate a corner of the housing 12, away from a first interface opening 24 that is formed partly in each of the upper and lower bodies 16 and 18. A second interface opening 25 is also shown located at one end of the housing 12; it will be understood that other interface openings are contemplated according to particular configurations of electronic devices to be protected by the case 10.

In one exemplary configuration, the hinged connection of the panel 14 is by means of a laterally spaced pair of hinge tabs 28 that are formed as extensions from an upper edge 30 of the panel 14, each hinge tab having an oppositely extending pair of bosses 32, the four bosses being aligned coaxially in spaced parallel relation to the upper edge 30. The upper body 16 has a generally rectangular access opening 34 for receiving the panel 14 in a generally flush closed condition thereof, the opening 34 having a pair of rectangular enlargements 36 for correspondingly receiving the hinge tabs 28. The upper body also has a pair of boss cavities 38 formed at opposite sides of each rectangular enlargement for snap pivotal engagement of the bosses 32 as shown in FIG. 6. It will be understood that the boss cavities can face downwardly as shown in FIG. 5, or upwardly for facilitating removal (detachment) of the panel 14, if desired.

The panel 14 also has a laterally spaced pair of catch tabs 40 extending from a lower edge 42 of the panel 14, the catch tabs having releasable engagement with corresponding catch cavities 44 that are formed in the upper body 16 for releasably holding the panel member in the closed position as shown in FIG. 6. The panel 14 also has an outwardly projecting lip pull 46 formed long a portion of the lower edge 42 between the catch tabs 40, and the opening 34 of the upper body 16 has a partially circular enlargement 48 adjacent the lip pull for facilitating opening of the panel 14 by a user's finger or thumb (not shown), the enlargement 48 being adapted for exposing an audio transducer (not shown) of an electronic device (also not shown) that can be enclosed within the housing 12.

An important feature of the present invention is that the combination of the catch tabs 40 with the lip pull 46 and the adjacent access opening enlargement 48 provide closure of the panel 14′ that is secure against typical handling of the case 10, yet the panel can be easily opened when desired. The housing 12 can also include conventional mount hardware 49 for attaching to an external support as shown in FIG. 2.

Suitable materials for the case 12 include high-strength thermoplastic polymers such as ABS and polypropylene. The protective panel 14 is preferably formed of a transparent material for convenient viewing of an enclosed electronic device display. Suitable materials for the panel 14 include clear polystyrene.

With further reference to FIGS. 7-11, an alternative configuration of the case, designated 10′, includes counterparts of the housing, designated 12′, and the protective panel, designated 14′, the housing having counterparts of the upper body, designated 16′, and the lower body, designated 18′. The panel 14′ includes a laterally spaced pair of arm members 50 that project beyond a counterpart of the upper edge 30 in parallel-spaced relation straddling the housing 12′, each arm member having an inwardly facing boss 32′ that engages a longitudinal channel 52 that is formed along opposite sides of the lower body 18′. In this configuration, the arm members 50 and bosses 32′ replace the hinge tabs 28 and bosses 32 of the configuration of FIGS. 1-6, described above. Circular boss cavities are formed proximate each end of each of the channels 52 as shown in FIG. 10, those closest to an end extremity of the housing 12′ being designated first boss cavities 38′A, the others being designated second boss cavities 38′B, being collectively designated 38′. According to the present invention, the bosses 32′ have snap engagement with the channels 52 as well as snap pivotal engagement with the boss cavities 38′, the arm members being sufficiently elastic to be spread apart such that at least one of the bosses 32′ at a time clears the corresponding channel 52 and, preferably, sufficiently further to effect disengagement (removal) of the panel 14′ from the housing 12′. The snap engagement with the first pair of boss cavities 38′A is shown in FIG. 7, and with the second pair of boss cavities 38′B is shown in FIGS. 8 and 9. The channels 50 and the boss cavities 38′ replace the rectangular enlargements 36 of the access opening 34 and the boss cavities 38 of the configuration of FIGS. 1-6. Thus the protective case 10′ provides plural attachment locations of the protective panel 14′ on the housing 12′ in that the engagement of the bosses 32′ with the first boss cavities 38′A provides one attachment location of the panel 14′ on the housing 12′, while such engagement with the second boss cavities 38′B provides a different attachment location.

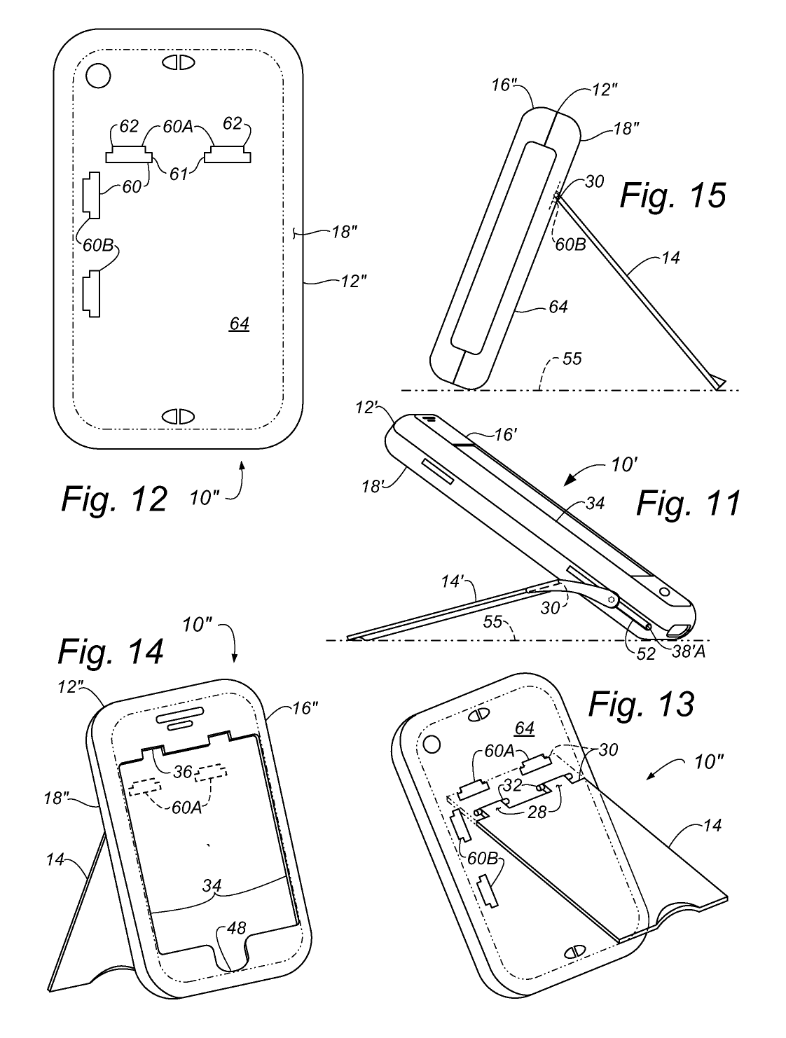

FIG. 7 shows the protective panel 14′ in a closed condition, the bosses 32′ engaging the boss cavities 38′A. FIG. 8 shows the protective panel 14′ in a first open position that is inclined upwardly and outwardly away from the access opening 34 for convenient direct access thereto. In the first open position the bosses 32′ engage the second boss cavities 38′B so that the upper edge 30 of the panel 14 rests on the upper body 16′ for supporting the panel in a predetermined angular inclination relative to the housing 12′. From the closed condition shown in FIG. 7, the protective panel 14′ can be pivoted beyond the first open position to a second open position extending under the housing 12′ as shown in FIG. 9, the upper edge 30 contacting the bottom of the lower body 18′ for supporting the housing in a predetermined inclination relative to a supporting surface 55. FIG. 11 shows the protective panel 14′ shifted to a third open position with the bosses 32′ engaging the second boss cavities 38′B for supporting the housing 12′ at a somewhat lesser inclination than in the second open position of FIG. 9.

With further reference to FIGS. 12-15, another alternative configuration of the case, designated 10″, includes counterparts of the housing, designated 12″, and the protective panel 14, the housing having counterparts of the upper body, designated 16″, and the lower body, designated 18″. The lower body is formed having a plurality of receiver openings 60 for selectively receiving the hinge tabs 28 and bosses 32 of the protective panel 14 for utilizing the panel as a stand propping up the housing 12″ as shown in FIGS. 14 and 15. More particularly, each receiver opening 60 has an elongate first portion 61 for entry of a pair of the bosses 32 projecting from one hinge tab 28, and a second portion 62 of reduced length for receiving the hinge tab alone, a pair of the openings 60 being suitably spaced apart and configured for hook engagement of the protective panel 14 with the upper edge 30 thereof proximate a bottom surface 64 of the lower body 18″.

FIG. 13 shows the protective panel 14 being engaged with a first pair of the receiver openings, designated 60A, for supporting the housing 12″ inclined upwardly from one end thereof as shown in FIG. 14. Similarly, FIG. 15 shows the housing 12″ inclined upwardly from one side thereof when the protective panel 14 is engaged with a second pair of the receiver openings, designated 60B. In the configuration of FIGS. 12-15, each pair of receiver openings 60 provides a different attachment location for the protective panel 14 in addition to that provided by the boss cavities 38 that pivotally locate the panel as shown in FIGS. 1 and 2.

Although the present invention has been described in considerable detail with reference to certain preferred versions thereof, other versions are possible. For example, the protective panel 14 can be hingedly connected to the housing 12 at a side edge instead of the top edge 30, the lip pull 46 and the catch tabs 40 being on the opposite side edge of the panel 14. Further in the configuration of FIGS. 7-11, the bosses 32′ can be non-circular, with one pair of boss cavities (such as cavities 38′A) being circular for pivotal support of the protective panel 14′, there being one or more additional boss cavities (such as the cavities 38′B) that are non-circular for selective engagement in one or more predetermined orientations of the protective panel. Moreover, there can be frictional engagement of the panel with the housing whereby the panel is held in any desired pivotal orientation within its range of movement. Therefore, the spirit and scope of the appended claims should not necessarily be limited to the description of the preferred versions contained herein.

What is claimed is:

1. A cell phone case, including a housing for holding an electronic device having a display panel, the housing having an access opening for accessing the display panel, and a protective panel, the panel having a pivotal connection to the body and being movable between a closed position protectively covering the display panel and an open position, characterized in that the panel has an outwardly projecting lip pull formed along an edge thereof opposite the pivotal connection, and the body having an enlargement of the access opening extending away from the lip pull in the closed position of the panel for facilitating opening of the panel.

2. The case of claim 1, having catches on the panel for releasably holding the panel in the closed position.

3. The case of claim 1, wherein the protective panel is engagable with the housing in a predetermined orientation relative to the housing for propping up the housing on an external supporting surface, with one edge of the housing and the edge of the protective panel having the lip pull contacting the supporting surface, and with the access opening facing generally upward.

4. The case of claim 1, wherein the panel is detachably attached to the body.

5. The case of claim 4, wherein the panel has plural attachment locations on the body.

6. The case of claim 5, wherein the pivotal connection of the protective panel to the housing is at a first attachment location, a second attachment location being proximate a bottom surface of the housing, wherein the protective panel is engeable in a predetermined orientation relative to the housing for propping up the housing on an external supporting surface, with one edge of the housing and the edge of the protective panel having the lip pull contacting the supporting surface, and with the access opening facing generally upward.

7. The case of claim 6 wherein:
(a) the protective panel is formed having a spaced pair of hinge tabs, each of the hinge tabs having an oppositely oriented boss projecting therefrom, the bosses being axially aligned, and wherein the housing is formed with the access opening having a pair of tab enlargements for clearing the hinge tabs, there being a pair of boss cavities formed in the housing adjacent each of the tab enlargements for snap pivotable engagement with the bosses; and
(b) the housing is formed having a spaced pair of openings at the second attachment location for receiving the bosses and portions of the hinge tabs of the protective panel.

8. The case of claim 6, further comprising a third attachment location proximate the bottom surface of the housing for selectively orienting the protective panel for propping up the housing with a different edge of the housing and the edge of the protective panel having the lip pull contacting the supporting surface.

9. The case of claim 1, wherein the housing comprises an upper body and a lower body.

10. The case of claim 9, further comprising mating attachment elements formed on the upper body and the lower body for holding same in an assembled condition to releasably secure the electronic device within the housing.

11. The case of claim 1, wherein the protective panel is transparent.

12. The case of claim 1, wherein the protective panel is formed having a spaced pair of hinge tabs, each of the hinge tabs having an oppositely oriented boss projecting therefrom, the bosses being axially aligned, and wherein the housing is formed with the access opening having a pair of tab enlargements for clearing the hinge tabs, there being a pair of boss cavities formed in the housing adjacent each of the tab enlargements for snap pivotable engement with the bosses.

13. A cell phone case, including a housing for holding an electronic device having a display panel, the housing having an access opening for accessing the display panel, and a protective panel, the panel having a pivotal connection to the body and being movable between a closed position protectively covering the display panel and an open position, wherein:
(a) the panel is formed with an outwardly projecting lip pull formed along an edge thereof opposite the pivotal connection for facilitating opening of the panel, and
(b) the protective panel is engagable with the housing in a predetermined orientation relative to the housing for propping up the housing on an external supporting surface, with one edge of the housing and the edge of the protective panel having the lip pull contacting the supporting surface, and with the access opening facing generally upward.

14. The case of claim 13, having catches on the panel for releasably holding the panel in the closed position.

15. A cell phone case, including a housing for holding an electronic device having a display panel, the housing having an access opening for accessing the display panel, and a transparent protective panel, the panel having a pivotal connection to the body and being movable between a closed position protectively covering the display panel and an open position, wherein
(a) the panel is formed having catches on the panel for releasably holding the panel in the closed position an outwardly projecting lip pull formed along an edge thereof opposite the pivotal connection for facilitating opening of the panel, and
(b) the protective panel is engagable with the housing in at least two predetermined orientations relative to the housing for propping up the housing on an external supporting surface, with one edge of the housing and the edge of the protective panel having the lip pull contacting the supporting surface, and with the access opening facing generally upward.
